(19) United States
(12) Patent Application Publication
(10) Pub. No.: US 2013/0317934 A1
(43) Pub. Date: Nov. 28, 2013

(54) Method for Soliciting Invitations to Offer for Unique Items Including Real Property

(71) Applicant: Christopher L. Brien, Scottsdale, CA (US)

(72) Inventor: Christopher L. Brien, Scottsdale, CA (US)

(21) Appl. No.: 13/479,430

(22) Filed: May 24, 2012

(51) Int. Cl. G06Q 30/06

(52) U.S. Cl. 705/26.4

(57) ABSTRACT

An ecommerce application for soliciting invitations to offer whereby a buyer or lessee, creates an account with a website based Controller, and a seller or lessor enlists in a subscription service with the Controller. The Controller creates an algorithm driven email distribution process comprising a plurality of emails sent to appropriate subscribers including vendors that contain an invitation to make an offer based on the information in a buyer's query. Subscribers then submit invitations for offers directly to the buyer or to the Controller for viewing by the buyer.

### CROSS REFERENCE TO RELATED APPLICATIONS

The present application depends from Provisional Application 61/519,762.

### STATEMENT REGARDING FEDERALLY SPONSORED RESEARCH OR DEVELOPMENT

Not Applicable.

### BACKGROUND OF THE INVENTION

1. Field of the Invention

The present invention relates to electronic commerce applications using digital and analog networks. More specifically, the present invention relates to a buyer-oriented method for using networks to solicit invitations to make an offer for unique items including real property.

2. Description of Related Art

The current art is crowded with template based methods for generating offers for goods or intangible items such as tickets or services such as hotel services or airline services. The current art also includes means for tracking preferences of a buyer so as to cull a large population of offers against preference criteria and/or to automatically identify offers that meet parameters algorithmically generated by buyer preference criteria patterns. The current art does not however include the present invention which is a means for soliciting invitations to offer for unique items including real property and ancillary services from private parties, commercial entities, and/or professionally represented parties.

### SUMMARY OF THE INVENTION

The present invention relates to an ecommerce application whereby a buyer (herein ‘buyer’ may also include the buyer of a lease-a lessee), creates an account with a website based Controller, and a seller (herein ‘seller’ may include lessor) enlists in a subscription service with the Controller. A buyer's account includes in part a template-based query for a unique item such as real property. Upon approval of the query by the buyer, the query is then submitted to the Controller. The Controller uses the query to create an email blast comprising a plurality of emails sent to appropriate subscribers that contain solicitations for invitations to make an offer based on the information in the buyer's query. Subscribers then submit invitations for offers to the Controller for viewing by the buyer. Unique items include but are not limited to: real property; services; and goods that are specially prepared (such as artwork), preowned (including vehicles and vehicle parts), and/or one of a kind items.

In use for commercial property sales or leasing, the present invention offers a buyer the option to submit a query (comprising property requirements) via the internet to property owners and their agents. A buyer can quickly receive responses that include property data and floor plans, decide which properties they would like to see on their schedule and arrange a tour. The buyer has now completed the task of finding suitable commercial and residential property potentially within minutes instead of days or weeks. When the buyer sends out their query they have the option to make the query visible to vendors offering ancillary services. Vendors include but are not limited to: appraisers, moving companies, architects, furniture companies, landscapers, janitorial companies, and contractors. Vendors then have the opportunity to reply to the query with any pertinent information that may apply to the buyer's specific requirement. This process will speed up the selection process for the buyer as well as provide additional work for vendors.

Therefore, it is an object of the present invention to provide a novel method for conducting commerce that enables a buyer to solicit invitations to make an offer for unique items including real property.

The characteristics and utilities of the present invention described in this summary and the detailed description below are not all inclusive. Many additional features and advantages will be apparent to one of ordinary skill in the art given the following description. There has thus been outlined, rather broadly, the more important features of the invention in order that the detailed description thereof that follows may be better understood, and in order that the present contribution to the art may be better appreciated.

In this respect, by explaining at least one embodiment of the invention in detail, it is to be understood that the invention is not limited in its application to the details of construction and to the arrangements of the components set forth in the description. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the description be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, nor is it intended to be limiting as to the scope of the invention in any way.

It is therefore another object of the present invention to eliminate the need for a buyer to examine numerous offers for unique items that do not meet their criteria.

It is another object of the present invention to eliminate the need for a buyer to examine numerous offers for unique items that may have already been sold or contain old information about the item.

It is another object of the present invention to provide a method for generating invitations to offer where offers for certain unique items such as real property must include certain terms.

It is another object of the present invention to provide a method for generating invitations to offer for ancillary services in support of a potential sales contract or lease of a unique item such as real property; ancillary services may include appraisal service, buyer's agent service, escrow service and/or any other appropriate service.

It is another object of the present invention to provide a method of commerce for industries often involving representation by an agent, e.g. a commercial property buyer's agent, wherein said method imposes visibility on the availability of all suitable offers and thereby eliminates agent bias, “brokering” or “steerage” which is currently permissible in the commercial property selling and leasing industry.

The characteristics and utilities of the present invention described in this summary and the detailed description below are not all inclusive. Many additional features and advantages will be apparent to one of ordinary skill in the art given the following detailed description.

### BRIEF DESCRIPTION OF THE DRAWINGS

FIG. 1 is a flow chart of the process for soliciting invitations to offer via a software and website means.

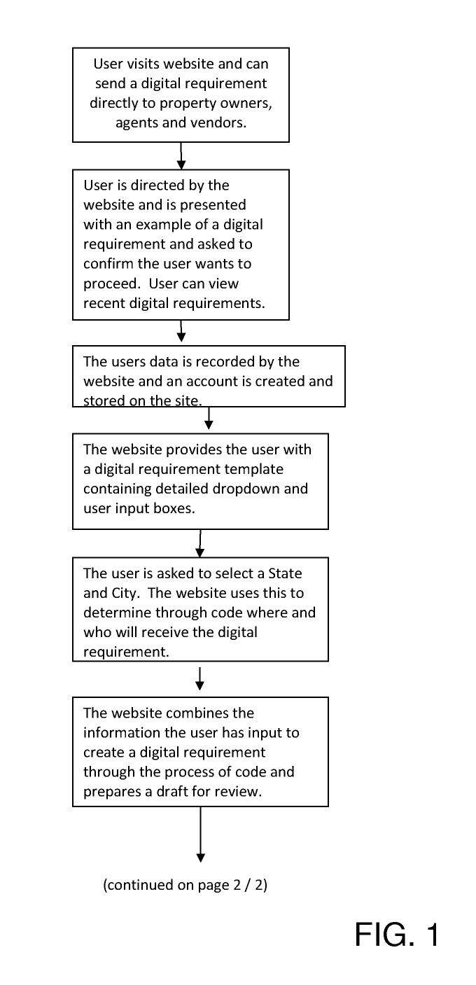

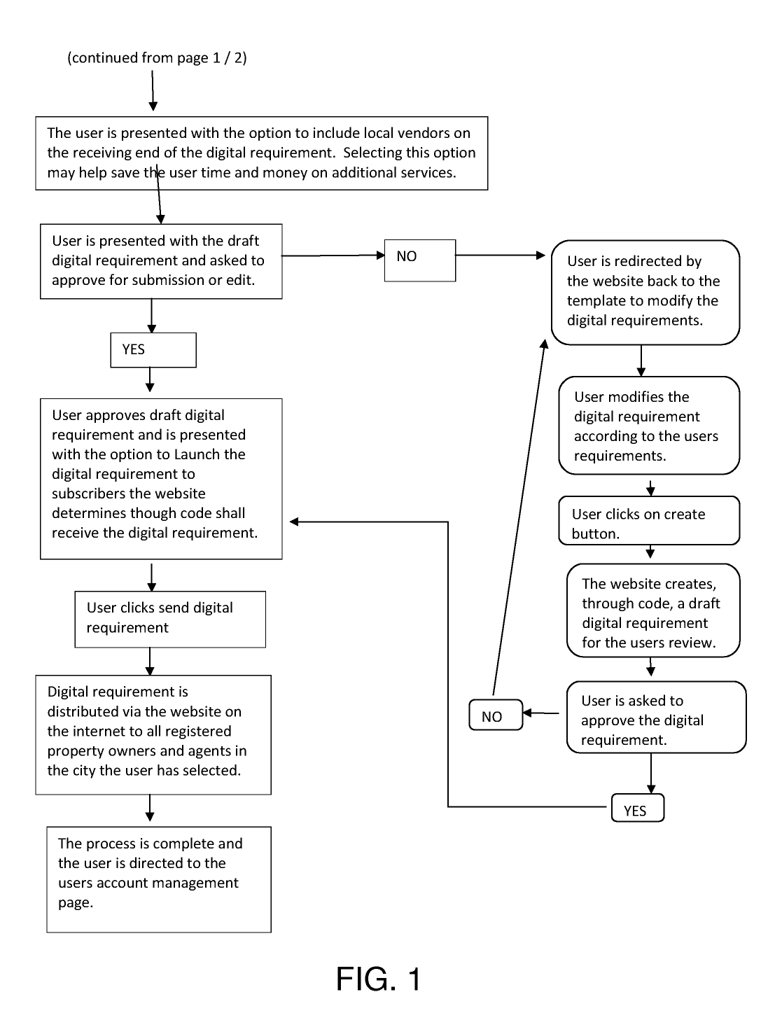

### DETAILED DESCRIPTION

A buyer-oriented ecommerce method for generating invitations to make an offer from sellers of unique items including real property. In use, the present invention is well described when it is used for the sale or lease of commercial real property. The commercial real property buyer is prompted to complete a registration section by the Controller website (herein ‘the website’) that is recorded by the website and an account is created and stored on the site. The buyer's information may be recorded in any known information storage device, including but not limited to RAM, Magnetic Media (e.g. a hard drive), a server, or any other electronic medium.

The website provides the buyer the necessary digital choices to complete a query with a template for an eblast communication containing detailed dropdown choices and input boxes that buyer completes according to the buyer's preferences, including but not limited to City, State, Property Type, Size, Location, etc. based on the buyer's requirements. The website uses the City and State selection to determine the registered property owners and agents that will receive the eblast. The buyer is given the choice to have a website generated email address created and/or to use a website generated workstation in order to keep the buyer's personal contact information from being accessible to any recipients of the eblast. Once the buyer has completed the template and selected the privacy email address the buyer is presented with the option to select whether the eblast will also be sent to local and national vendors.

The website combines all query requirements, the privacy option selection and the vendor option selection entered by the buyer into a draft eblast for the buyer's approval. The buyer is presented with a draft of how the eblast will appear to appropriate subscribers. The appearance may be, but is not limited to, the written signal (e.g. webpage), an electronic signal (e.g. email), a visual signal (e.g. video monitor) etc. The buyer is presented with the option to send the eblast via the website to all registered property owners, agents and vendors (if applicable). The option to send the eblast via the website may be in the form of a clickable button, link, or any other method necessary to instruct the website to send the eblast to all registered property owners, agents and vendors.

Upon approval by the Controller, the website distributes the eblast through the website via the Internet to all registered subscribers including property owners, agents, and buyer's that the website has determined fit the location criteria entered by the buyer. The website sends the buyer a confirmation correspondence via email confirming the appearance and distribution of the eblast.

Using the above ecommerce method allows a buyer to solicit multiple invitations to make an offer for items that are unique, including real property. The invitations to make an offer are provided by the query-driven subscriber pool and include detailed information about the item that may comprise the elements of a contract for sale or lease.

The previous is a detailed description of embodiments of the present invention. As these embodiments of the present invention are described, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, the description is not to be considered in a limiting sense, as it is understood that the present invention is in no way limited to the embodiments described.

What is claimed is:

1. A method for soliciting invitations to offer for unique items comprising:
1. A platform-agnostic software application and website means whereby a buyer of a unique item such as real property completes a template describing the user's desired criteria for said item and submits said template to a website controller who submits said template to a set of registered unique item sellers without disclosing said user's identity or personal data; said user then receives invitations to make an offer from said registered unique item sellers that intend to sell a unique item according to said user's template criteria.
2.
